(19) United States
(12) Patent Application Publication
(10) Pub. No.: US 2020/0342639 A1
(43) Pub. Date: Oct. 29, 2020

(54) SINGLE CT BACKPROJECTOR WITH ONE GEOMETRY CALCULATION PER VOXEL FOR MULTIPLE DIFFERENT TYPES OF PROJECTION DATA

(71) Applicant: KONINKLIJKE PHILIPS N.V., EINDHOVEN (NL)

(72) Inventors: KEVIN MARTIN BROWN, CHARDON, OH (US); THOMAS KOEHLER, NORDERSTEDT (DE); ROLF DIETER BIPPUS, HAMBURG (DE)

(21) Appl. No.: 15/733,084

(22) PCT Filed: Nov. 5, 2018
(86) PCT No.: PCT/EP2018/080111

§ 371 Date: May 13, 2020

Related U.S. Application Data
(60) Provisional application No. 62/585,672, filed on Nov. 14, 2017.

(51) Int. Cl. G06T 11/00; G06T 15/08; G01N 23/046

(52) U.S. Cl. CPC G06T 11/006; G06T 11/008; G01N 2223/419; G01N 23/046; G06T 2211/408; G06T 15/08

(57) ABSTRACT

A system includes a single backprojector (120), which includes a single geometry calculator (204), at least one weight calculator (206), and a plurality of data interpolators (208). The single geometry calculator is configured to process scan parameters of a single computed tomography scan to generate geometry values only once for each voxel position in a volumetric image data matrix. The at least one weight calculator is configured to process the scan parameters of the single computed tomography scan and the geometry values to generate weight values for each voxel position in the volumetric image data matrix. Each of the plurality of data interpolators is configured to process, using the weight values and the same geometry values, a respective different type of projection data produced from the same single computed tomography scan to generate volumetric image data based on the volumetric image data matrix and corresponding to the respective different type of projection data.

### FIELD OF THE INVENTION

The following generally relates to computed tomography (CT) and more particularly to a single backprojector configured to perform only one geometry calculation per voxel for a scan and employ the geometry values and weight values to process multiple different types of projection data for the scan.

### BACKGROUND OF THE INVENTION

A computed tomography (CT) scanner generally includes an x-ray tube mounted on a rotatable gantry opposite one or more rows of detectors. The x-ray tube rotates around an examination region located between the x-ray tube and the one or more rows of detectors and emits radiation that traverses the examination region and an object disposed therein. The one or more rows of detectors detect radiation that traverses the examination region and generate a signal (projection data) indicative of the examination region and the object disposed therein. The projection data is reconstructed to generate volumetric image data. The voxels and/or pixels are displayed using gray scale values corresponding to relative radiodensity. A CT scanner configured for spectral (multi-energy) imaging generates multiple sets of spectral volumetric image data, each reflecting different intrinsic properties of a material being imaged (e.g., photoelectric effect, Compton scattering, etc.).

The different sets of spectral volumetric image data have been reconstructed separately, either serially or in parallel. With a series reconstruction, the reconstructor reconstructs one image type after another. Unfortunately, this results in a long reconstruction process, e.g., approximately X times the amount of time for X types of images relative to a single type of image. With a parallel reconstruction, multiple reconstruction chains are required, each with its own backprojector. Unfortunately, this increases overall cost of the backprojectors, approximately X times the amount X backprojectors relative to a single backprojector. In general, these issues arise when reconstructing multiple different image types from projection data belonging to the same scan. For example, reconstructing projection data and a noise estimate of the projection data in series or parallel would likewise increase reconstruction time and/or increase backprojector cost.

### SUMMARY OF THE INVENTION

Aspects described herein address the above-referenced problems and others.

The approach described herein, in one instance, allows a single backprojector to do the work of multiple backprojectors executing in parallel, in approximately the same amount of time. As such, overall cost of the reconstruction system can be reduced by using fewer backprojectors. Alternatively, processing time of other reconstruction steps can be improved by devoting more hardware resources to those algorithms. Alternatively, a combination of reduced cost and improved processing time can be achieved.

In one aspect, a system includes a single backprojector, which includes a single geometry calculator, at least one weight calculator, and a plurality of data interpolators. The single geometry calculator is configured to process scan parameters of a single computed tomography scan to generate geometry values only once for each voxel position in a volumetric image data matrix. The at least one weight calculator is configured to process the scan parameters of the single computed tomography scan and the geometry values to generate weight values for each voxel position in the volumetric image data matrix. Each of the plurality of data interpolators is configured to process, using the weight values and the same geometry values, a respective different type of projection data produced from the same single computed tomography scan to generate volumetric image data based on the volumetric image data matrix and corresponding to the respective different type of projection data.

In another aspect, a computer readable medium is encoded with computer executable instructions, which, when executed by a processor of a computer, cause the processor to: compute, with only one backprojector: geometry values only once for each voxel position in a volumetric image data matrix from scan parameters of a single computed tomography scan, one or more sets weight values for each voxel position in the volumetric image data matrix from scan parameters of the single computed tomography scan and the geometry values, and interpolate and add, using the same geometry values and using the one or more sets weight values, a respective different type of projection data produced from projection data from the same single computed tomography scan to generate volumetric image data based on the volumetric image data matrix and corresponding to the respective different type of projection data.

In another aspect, a method includes computing, with a single backprojector, geometry values for each voxel position in a volumetric image data matrix from scan parameters of a single computed tomography scan. The method further comprises: computing, with the single backprojector, weight values for each voxel position in the volumetric image data matrix from scan parameters of the single computed tomography scan and the geometry values. The method further comprises: interpolating and adding, with the single backprojector, different types of projection data, which are produced from a same projection data from the same single computed tomography scan, using the same geometry values and using the weight values to generate volumetric image data based on the volumetric image data matrix and corresponding to the respective different type of projection data.

### BRIEF DESCRIPTION OF THE DRAWINGS

The invention may take form in various components and arrangements of components, and in various steps and arrangements of steps. The drawings are only for purposes of illustrating the preferred embodiments and are not to be construed as limiting the invention.

FIG. 1 schematically illustrates an example imaging system that includes a reconstructor with a single backprojector configured to backproject, using the same geometry values, different types of projection data generated from projection data from a same single imaging scan.

FIG. 2 schematically illustrates an example of the backprojector of the reconstructor.

FIG. 3 schematically illustrates another example of the backprojector of the reconstructor.

FIG. 4 schematically illustrates yet another example of the backprojector of the reconstructor.

FIG. 5 schematically illustrates still another example of the backprojector of the reconstructor.

FIG. 6 schematically illustrates another example of the backprojector of the reconstructor.

FIG. 7 illustrates an example method in accordance with an embodiment(s) described herein.

FIG. 8 illustrates another example method in accordance with an embodiment(s) described herein.

### DETAILED DESCRIPTION OF EMBODIMENTS

The following generally describes an approach for backprojection of different types of projection data generated from the same projection data from a same single imaging scan using the same geometry values for all of the different types of projection data. In general, a single geometry calculation and one or more weight calculations are performed for each voxel position (x, y, z) in a volumetric image data matrix, producing the geometry and weight values. Then, interpolation and additions are performed for each type of data using the same geometry value and the one or more weight values, generating volumetric image data for each type of data. As described in greater detail below, in one instance this approach provides a time and/or cost efficient backprojection, relative to a configuration in which multiple backprojectors are employed in parallel, each performing its own geometry calculation, followed by interpolation and additions.

This approach can be applied with spectral (multi-energy) CT, e.g., where the spectral projection data includes high and low energy projection data, at least two basis components (e.g., photo-electric effect and Compton scattering), and/or two or more different energy spectrums. In this instance, the same geometry values are used for the interpolation and additions to generate all of the spectral volumetric image data. This approach can also be used for reconstructing noise images. In this instance, the same geometry values are used for the interpolation and additions of both the projection data and a noise estimated therefrom to generate volumetric image data for the original data and the estimated noise. An example of a suitable noise reconstruction is described in U.S. patent application 62/430,424, titled “IMAGE NOISE ESTIMATION USING ALTERNATING NEGATION” and filed Dec. 6, 2016, which is incorporated by reference in its entirety herein. This approach can also be used with a combination of the above and/or other applications which produce at least two different types of projection data from the same single imaging scan.

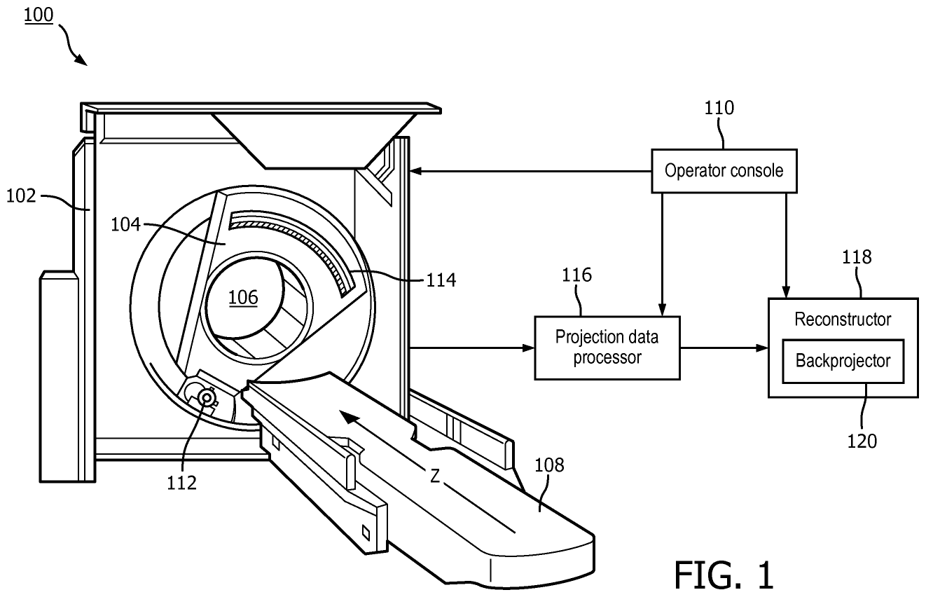

FIG. 1 schematically illustrates an imaging system 100 such as a computed tomography (CT) scanner. The imaging system 100 includes a generally stationary gantry 102 and a rotating gantry 104. The rotating gantry 104 is rotatably supported by the stationary gantry 102 and rotates around an examination region 106 about a longitudinal or z-axis. A subject support 108, such as a couch, supports an object or subject in the examination region 106. The subject support 108 is movable in coordination with performing an imaging procedure so as to guide the subject or object with respect to the examination region 106 for loading, scanning, and/or unloading the subject or object. An operator console 110 allows an operator to control an operation of the system 100. This includes selecting an imaging acquisition protocol, selecting a reconstruction algorithm, invoking scanning, etc. The operator console 110 includes an output device(s) such as a display monitor, a filmer, etc., and an input device(s) such as a mouse, keyboard, etc.

A radiation source 112, such as an x-ray tube, is rotatably supported by the rotating gantry 104. The radiation source 112 rotates with the rotating gantry 104 and emits X-ray radiation that traverses the examination region 106. In one instance, the radiation source 112 is a single x-ray tube configured to emit broadband (polychromatic) radiation for a single selected peak emission voltage (kVp) of interest (i.e. the energy spectrum at that kVp). In another instance, the radiation source 112 is configured to switch between at least two different emission voltages (e.g., 70 keV, 100 keV, etc.) during scanning. In yet another instance, the radiation source 112 includes two or more x-ray tubes angular offset on the rotating gantry 104 with each configured to emit radiation with a different mean energy spectrum. In still another instance, the radiation source 112 includes a combination of the above. U.S. Pat. No. 8,442,184 B2 describes a system with kVp switching and multiple x-ray tubes, and is incorporated herein by reference in its entirety.

A radiation spectrum sensitive detector array 114 subtends an angular arc opposite the radiation source 112 across the examination region 106. The detector array 114 includes one or more rows of detectors that are arranged with respect to each other along the z-axis 108 direction and detects radiation traversing the examination region 106. In the illustrated embodiment, the detector array 214 includes an energy-resolving detector such as a multi-layer scintillator/photo-sensor detector (e.g., U.S. Pat. No. 7,968,853 B2, which is incorporated herein by reference in its entirety) and/or a photon counting (direct conversion) detector (e.g., WO 2009/072056 A2, which is incorporated herein by reference in its entirety). With an energy-resolving detector, the radiation source 112 includes the broadband, kVp switching and/or multiple X-ray tube radiation source 112. In another instance, the detector array 114 includes a non-energy-resolving detector, and the radiation source 112 includes the kVp switching and/or the multiple X-ray tube radiation source 112. The detector array 114 generates spectral projection data (line integrals) indicative of the different energies.

A projection data processor 116 processes the spectral projection data and generates at least two different sets of spectral projection data. For example, in one instance the projection data processor 116 executes a decomposition algorithm to decompose the spectral projection data to generate photo-electric effect projection data and Compton scattering projection data (and, optionally, a combination thereof). Other examples include water and iodine projection data sets, water and calcium projection data sets, calcium and iodine projection data sets, bone and soft tissue projection data sets, etc. Where the projection data is representative of three or more energies, the projection data processor 116 can generate three or more basis material projection data sets. Other types of data sets include, but are not limited to, high and low energy, mono-energetic/monochrome, effective Z (atomic number), k-edge, etc. spectral projection data sets. Where the projection data includes high/low energy, multiple different energy spectrums, etc. data sets to be backprojected, the projection data processor 116 can operate as a pass through.

A reconstructor 118 processes the sets of projection data and generates volumetric image data (voxels) for each of the data sets. As described in greater detail below, the reconstructor 118 includes only a single backprojector 120 to backproject the different sets projection data to generate volumetric image data for each of the different types of projection data. In one instance, this can reduce processing time and/or cost relative to a configuration in which the different sets of projection data are instead processed serially or in parallel with multiple backprojectors. For example, relative to serial processing, the approached described herein can reduce at least part of the reconstruction time by a factor of K, where K is the number of data sets processed. In another example, relative to parallel processing, the approached described herein can reduce at least part of the reconstruction hardware (the number of backprojectors) by a factor of K, which reduces cost. Optionally, at least part of the cost savings can be used to procure more and/or higher end and faster hardware to reduce reconstruction time.

The projection data processor 116 and/or the reconstructor 118 are implemented via a processor (e.g., a central processing unit or CPU, a microprocessor, a controller, or the like) configured to execute computer executable instructions stored, embedded, encoded, etc. on computer readable storage medium (which excludes transitory medium), such as physical memory and/or other non-transitory memory. In one embodiment, the processor can execute computer executable instructions carried by transitory medium (which excludes non-transitory medium) such as a carrier wave, a signal, etc. In some embodiments, the reconstructor 118 includes specialized hardware for processing acceleration. Such hardware may include, but is not limited to a customized integrated circuit (IC), application specific integrated circuit (ASIC), field-programmable gate array (FPGA), graphics processing unit (GPU), and/or the like. The reconstructor 118 can be part of the system 100 (as shown) and/or a computing system separate and distinct from the system 100.

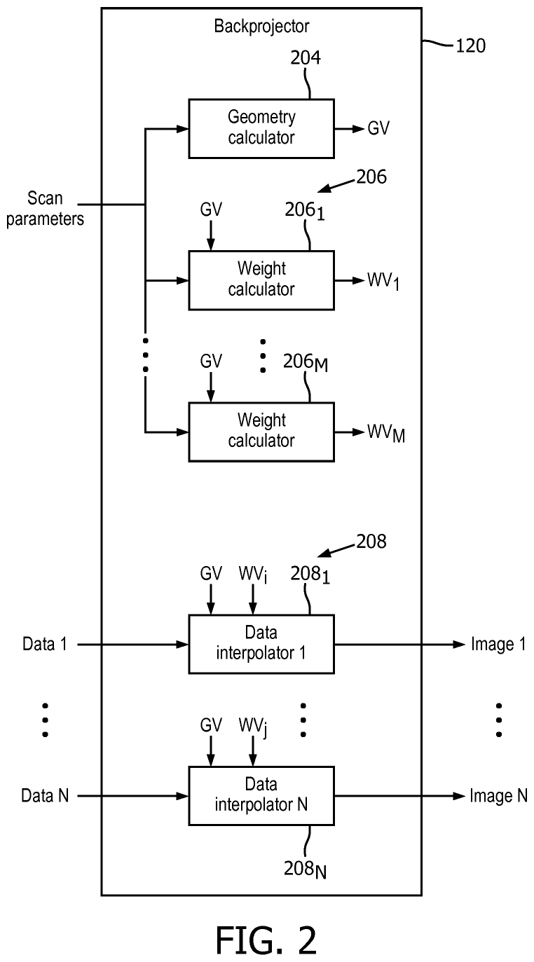

FIG. 2 schematically illustrates an example of the backprojector 120. From above, the backprojector 120 can be implemented via a CPU, IC, ASIC, FPGA, GPU, and/or processing unit. The illustrated single backprojector 120 is configured to perform multiple backprojection operations, at a same time and with the same hardware, rather than serially or in parallel on different backprojectors. In this example, the single backprojector 120 is configured to perform at least three backprojection operations. Geometry calculations are performed only once for each voxel across all data sets and produce geometry values. Weight calculations are performed one or more times for each voxel across all data sets and produce weight values, and the different data sets are separately interpolated in parallel using the same geometry values and the weight values from the geometry and weight calculations.

The backprojector 120 receives scan parameters of the scan that generated the projection data being processed. The scan parameters can be included in the data files (e.g., in a header) and/or received from the console 110 and/or the projection data processor 116. The scan parameters include a geometry of the scan and a geometry of the reconstruction volume. A geometry calculator 204 processes the scan parameters and generates geometry values (GV) only once for each voxel and projection. A set 206 of weight calculators 206₁, . . . , 206_{M} (where M is an integer equal or greater than one), processes the scan parameters and the geometry values, and generates weight values (WV₁, . . . , WV_{M}) for each voxel. Examples of scan parameters include a z-axis position of the subject support 108, an angular position of source 112, a width of the radiation beam emitted by the source 112, an angular position of a detector(s) of the detector array 114, a z-axis position of the detector(s), a rate of movement of the subject support 108, etc.

The backprojector 120 also receives the sets of projection data. In this example, the sets of projection data include N projection data sets, DATA 1, . . . , DATA N (collectively referred to herein as DATA), where N is a positive integer greater than one. A set of data interpolators 208₁, . . . , 208_{N} (collectively referred to herein as data interpolators 208) respectively interpolates the DATA, each interpolator using the same GV and one of the WV₁, . . . , WV_{M}. For example, the data interpolator 208₁ interpolates the DATA 1 using the GV and the WVᵢ (where 1≤i≤M) to generate volumetric image data 1 (image 1), . . . , and the data interpolator 208_{N} interpolates the DATA N using the same GV and the WVᵢ (where 1≤j≤M) to generate volumetric image data N (image N). In one instance, i=j. In another instance, i≠j. The data interpolators 208 can be implemented by way of a parallel computing architectures with dedicated hardware for performing the same interpolation on multiple different data types and/or otherwise.

The following mathematically describes a non-limiting algorithm of the backprojector 120 using aperture weights.

For this example, an aperture-weighted backprojection is described as shown in EQUATION 1:

$${image}_{d} ( x , y , z ) = {\sum }_{k} α ( w , k ) \cdot {data}_{d , k} ( u , w ) , \qquad EQUATION 1$$

where d represents a type of data (e.g., photo-electric, Compton scattering, combined, etc.), x, y, z represent a voxel coordinate, image_{d} (x, y, z) represents a backprojected voxel for an image of data type d at the coordinate x, y, z, k represents the projections, w and u represent the geometry values GV, α(w, k) represents a normalized aperture weighting, and data_{d,k}(u, w) represents a data interpolation term for a d-th type of data and a k-th projection. For the sake of brevity, the dependency of w and u on x, y, z, k is not explicitly written in EQUATION 1.

The geometry values u and w can be computed as shown in EQUATIONS 2 and 3:

u=x cos θₖ+y sin θₖ, EQUATION 2:

where θₖ represents the projection angle, and

$$w = \frac{{z}_{k} + asin ( \frac{u}{{R}_{s}} ) \cdot \frac{pitch}{2 π}}{\sqrt{{R}_{s}^{2} - {u}^{2}} - v} \qquad EQUATION 3$$

where Rₛ represents a distance from the source to iso-center, and v represents a distance of a ray from the source to the voxel being reconstructed.

The aperture weighting term α(⋅) can be computed as shown in EQUATION 4:

$$α = \frac{G ( {w}_{k} )}{{\sum }_{j ∈ p} G ( {w}_{j} )} , \qquad EQUATION 4$$

where p represents a set of all “pi-partners” of a current projection k (projections 180 degree away from projection k), and G( ) represents the aperture weight value WV. In this example, G( ) weights a projection, for a given voxel, traversing from the source 112 through the voxel and a detector of the detector array 114 based on a location of the detector in the detector array 114. An example of computing G( ) is described in U.S. Pat. No. 6,775,346 B2, filed Oct. 21, 2002, and entitled “Conebeam computed tomography imaging,” which is incorporated herein by reference in its entirety.

Generally, the geometry values u and w are first computed. Then, the aperture weighting α(w, k) is computed. Then, data interpolation and addition are performed for each data type d using the same u, w and α(w, k).

Although the above example is described in connection with aperture weights, it is to be understood that other backprojection weights are contemplated herein. For example, backprojection with an extended wedge algorithm utilizes weights, but not aperture-weights. An example of such an extended wedge algorithm is described in Schecter et al., “The frequency split method for helical cone-beam reconstruction,” Med. Phys. 31 (8), 2230-2236 (August 2004).

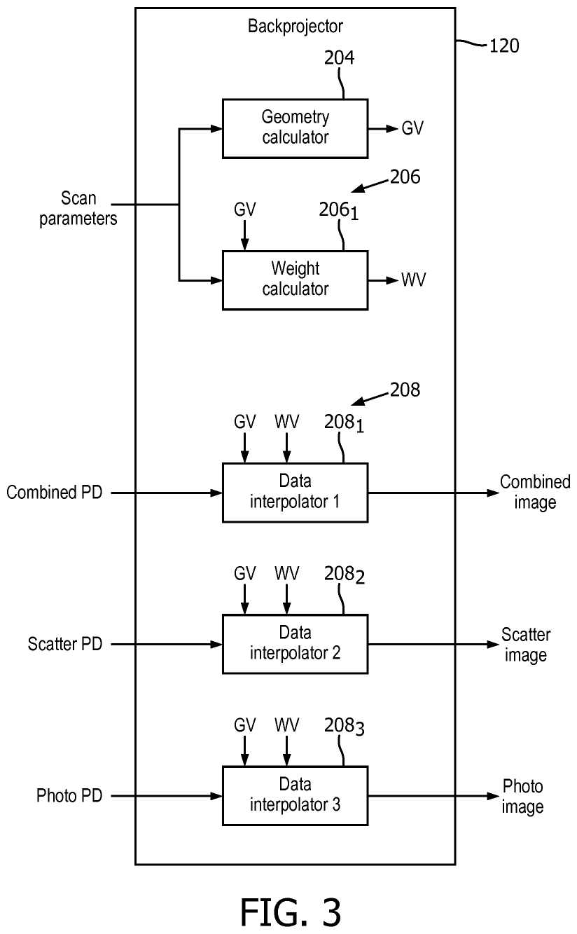

FIGS. 3-6 schematically illustrate non-limiting spectral imaging examples of the backprojector 120.

In FIG. 3, the backprojector 120 is configured with the single geometry calculator 204 and a single weight calculator 206₁. The backprojector 120 is further configured with three data interpolators 208₁, 208₂ and 208₃. The data interpolators 208₁, 208₂ and 208₃ respectively are configured to process Compton scatter projection data (scatter PD), photo-electric effect projection data (photo PD), and combined (conventional/non-spectral) projection data (combined PD), and generate Compton scatter volumetric image data (scatter image/non-spectral), photo-electric effect volumetric image data (photo image), and combined (conventional/non-spectral) volumetric image data (combined image). In this example, the single weight calculator 206₁ is configured to calculate full normalized aperture weights. The same geometry and aperture weights values are employed by all three of the data interpolators 208₁, 208₃ and 208₃.

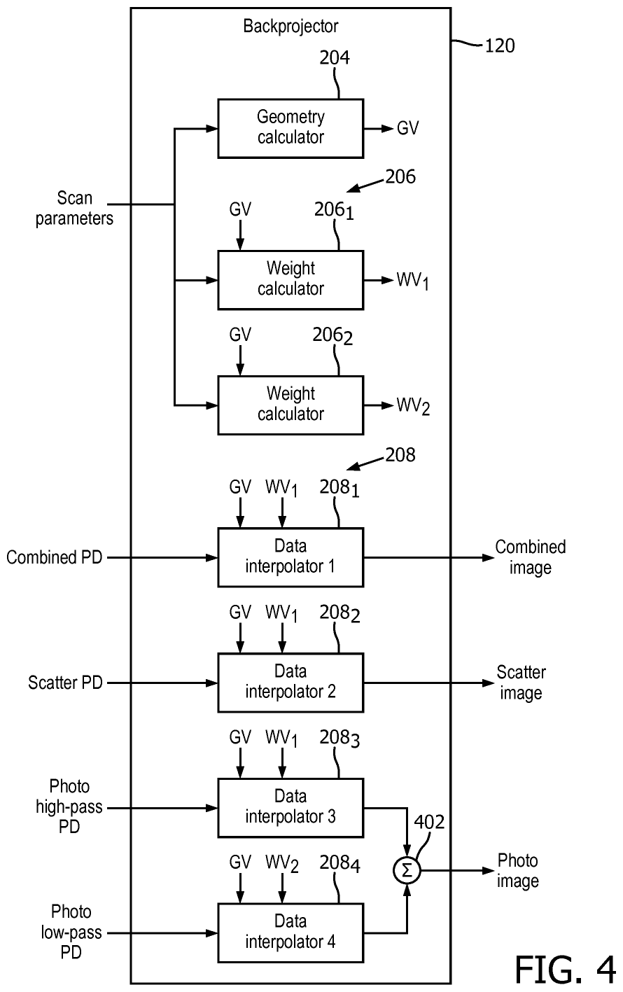

In FIG. 4, the backprojector 120 is configured with the single geometry calculator 204 and two weight calculators 206₁ and 206₂. The backprojector 120 is further configured with four data interpolators 208₁, 208₂, 208₃ and 208₄. The data interpolators 208₁, 208₂, 208₃ and 208₄ respectively are configured to process combined projection data (combined PD), Compton scatter projection data (scatter PD), high-pass photo-electric effect projection data (photo high-pass PD), and low-pass photo-electric effect projection data (photo low-pass PD), and generate combined (combined image), scatter (scatter image), high-pass photo-electric effect projection, and low-pass photo-electric effect projection data volumetric image data. A summer 402 sums the high and low photo-electric effect volumetric image data to produce photo volumetric image data (photo image).

In this example, the weight calculator 206₁ is configured to calculate full normalized aperture weights. The weight calculator 206₂ is configured to calculate narrow coverage normalized aperture weights. The data interpolators 208₁, 208₂, and 208₃ employ the full normalized aperture weights (from the weight calculator 206₁). The data interpolator 208₄ employs the narrow coverage normalized aperture weights (from the weight calculator 206₂). All of the data interpolators 208₁, 208₂, 208₃ and 208₄ employ the same geometry values (from the single geometry calculator 204). In this example, the projection data processor 116 (FIG. 1) includes high and low pass filters that filter the photo-electric effect projection data to produce the high and low photo-electric effect projection data. An example of frequency splitting is described in Schecter et al., “The frequency split method for helical cone-beam reconstruction,” Med. Phys. 31 (8), 2230-2236 (August 2004).

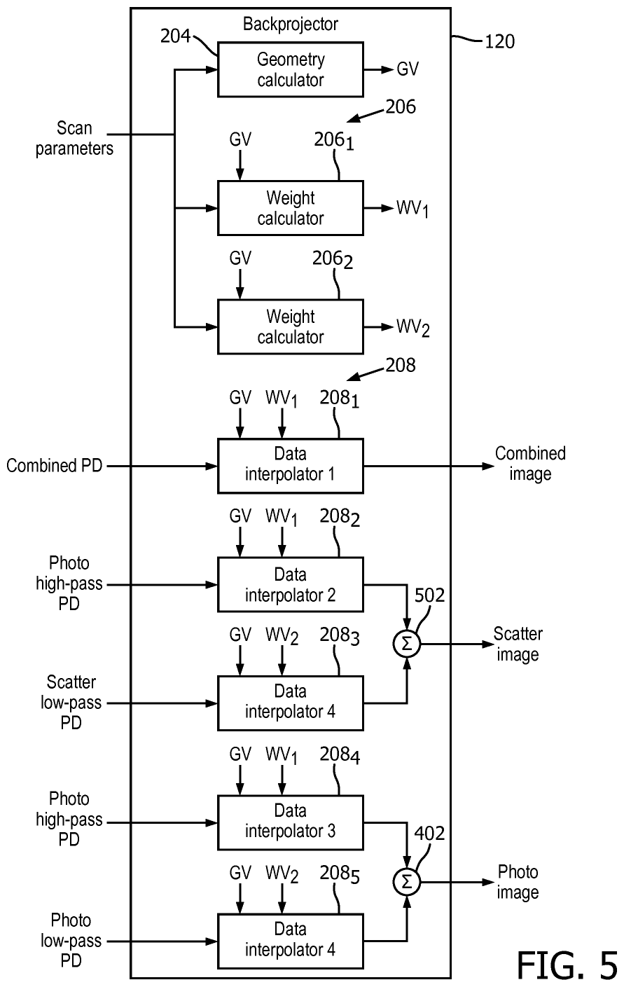

In FIG. 5, the backprojector 120 is configured with the single geometry calculator 204 and the two weight calculators 206₁ and 206₂. The backprojector 120 is further configured with five data interpolators 208₁, 208₂, 208₃, 208₄ and 208₅. The data interpolators 208₁, 208₂, 208₃, 208₄ and 208₅ respectively are configured to process combined projection data (combined PD), high and low-pass Compton scatter projection data (scatter high-pass PD and scatter low-pass PD), and high and low-pass photo-electric effect projection data (photo high-pass PD and photo low-pass PD), and generate combined volumetric image data (combined image), high and low-pass Compton scatter volumetric image data, and high and low-pass photo-electric effect volumetric image data. The summer 402 sums the high and low photo data to produce photo volumetric image data (photo image). A summer 502 sums the high and low scatter data to produce scatter volumetric image data (scatter image).

In this example, the weight calculator 206₁ is configured to calculate full normalized aperture weights. The weight calculator 206₂ is configured to calculate narrow coverage normalized aperture weights. The data interpolators 208₁, 208₂, and 208₄ employ the full normalized aperture weights (from the weight calculator 206₁). The data interpolators 208₃ and 208₄ employ the narrow coverage normalized aperture weights (from the weight calculator 206₂). All of the data interpolators 208₁, 208₂, 208₃, 208₄ and 208₅ employ the same geometry values. In this example, the projection data processor 116 (FIG. 1) includes high and low pass filters that filter the photo-electric effect projection data to produce the high and low photo-electric effect projection data, and high and low pass filters that filter the Compton scatter projection data to produce the high and low Compton scatter projection data.

The above examples are described next in connection with spectral CT. However, it is to be understood that the approach described herein can also be employed in other applications in which at least two different types of projection data are generated from the same single imaging scan. For example, the approach described herein can also be employed to generate volumetric image data from projection data and a noise estimate of the projection data using the same geometry values. Non-limiting examples of suitable noise estimation approaches are described in U.S. Pat. No. 9,159,122 B2, which is incorporated herein by reference in its entirety, and WO 2016/103088 A1, which is incorporated herein by reference in its entirety. Other algorithms are also contemplated herein.

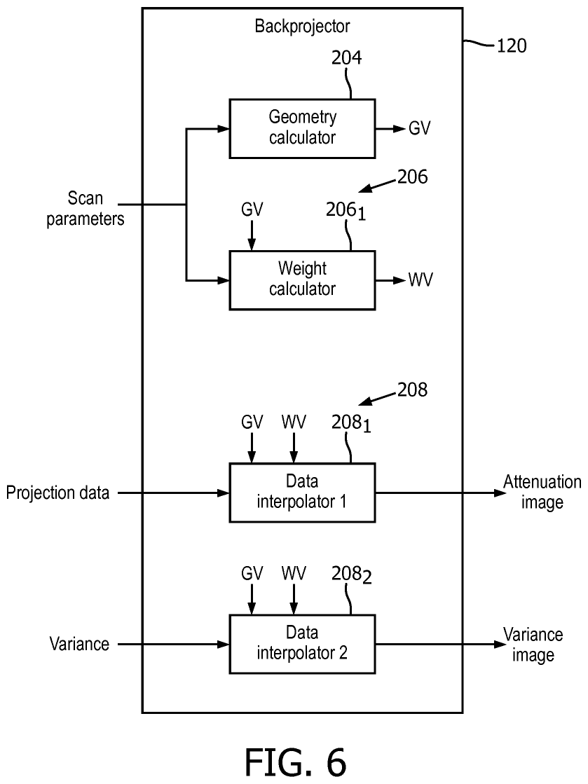

FIG. 6 schematically illustrates a non-limiting noise estimate example of the backprojector 120.

In FIG. 6, the backprojector 120 is configured with the single geometry calculator 204 and the weight calculator 206₁ and two data interpolators 208₁ and 208₂, respectively configured to process the projection data and the noise estimate (statistical variances) determined for the projection data, and generate attenuation volumetric image data (attenuation image) and noise volumetric image data (variance image). In this example, the weight calculator 206₁ is configured to calculate full normalized aperture weights (e.g., using squared weights). The same geometry values and the same aperture weights values are employed by both of the data interpolators 208₁ and 208₂. In this example, the projection data processor 116 (FIG. 1) processes the projection data to estimate the noise.

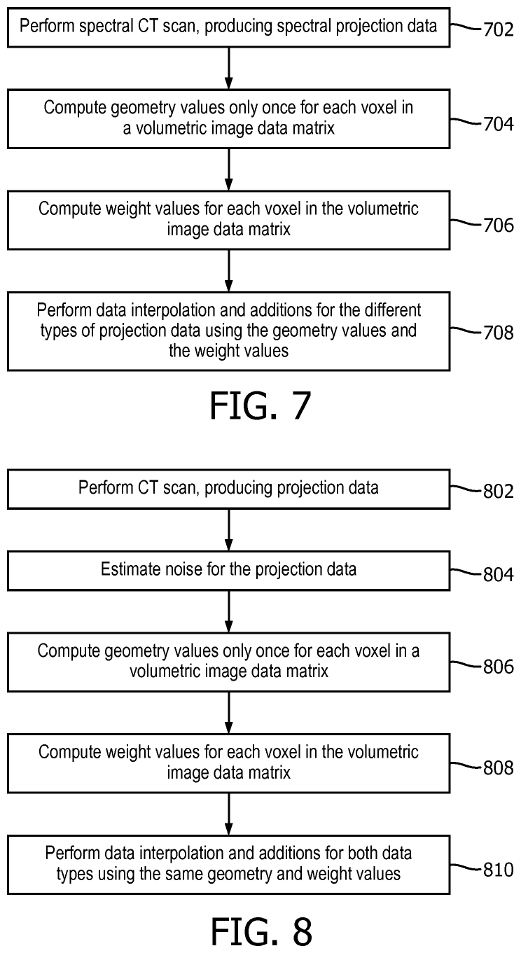

FIG. 7 illustrates an example method in accordance with an embodiment(s) described herein.

At 702, a spectral CT scan is performed, producing spectral projection data. In one instance, the spectral projection data includes at least two different types of spectral projection data. In another instance, the spectral projection data is processed to generate at least two different types of spectral projection data.

At 704, geometry values are generated based on scan parameters only once for each voxel in a volumetric image data matrix, as described herein and/or otherwise.

At 706, one or more sets of weight values are generated based on the scan parameters and the geometry values for each voxel in the volumetric image data matrix, as described herein and/or otherwise.

At 708, volumetric image data is generated for the different types of spectral projection data through separate interpolation and addition operations using the same geometry values and the one or more weight values, as described herein and/or otherwise.

As described herein, acts 704-708 are performed on/by the same backprojector 120.

FIG. 8 illustrates another example method in accordance with an embodiment(s) described herein.

At 802, a CT scan is performed, producing projection data.

At 804, a noise (e.g., variance) is estimated for the projection data, as described herein and/or otherwise.

At 806, geometry values are generated based on scan parameters only once for each voxel in a volumetric image data matrix, as described herein and/or otherwise.

At 808, one or more weight values are generated based on the scan parameters and the geometry values for each voxel in the volumetric image data matrix, as described herein and/or otherwise.

At 810, volumetric image data is generated for both the projection data and the noise estimate through separate interpolation and additions using the same geometry values and the weight values, as described herein and/or otherwise.

As described herein, acts 806-810 are performed on/by the same backprojector 120.

The above may be implemented by way of computer readable instructions, encoded or embedded on computer readable storage medium (which excludes transitory medium), which, when executed by a computer processor(s) (e.g., central processing unit (cpu), microprocessor, etc.), cause the processor(s) to carry out acts described herein. Additionally, or alternatively, at least one of the computer readable instructions is carried by a signal, carrier wave or other transitory medium, which is not computer readable storage medium.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims.

In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measured cannot be used to advantage.

A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. A system, comprising:
a single backprojector, including:
a single geometry calculator configured to process scan parameters of a single computed tomography scan to generate geometry values only once for each voxel position in a volumetric image data matrix;
at least one weight calculator configured to process the scan parameters of the single computed tomography scan and the geometry values to generate weight values for each voxel position in the volumetric image data matrix; and
a plurality of data interpolators, each configured to process, using the weight values and the same geometry values and, a respective different type of projection data produced from the same single computed tomography scan to generate volumetric image data based on the volumetric image data matrix and corresponding to the respective different type of projection data.

2. The system of claim 1, wherein the different types of projection data include spectral projection data for at least two different energy spectrums.

3. The system of claim 1, wherein the different types of projection data include at least a photo-electric effect component and a Compton scatter component.

4. The system of claim 3, wherein at least one of the photo-electric effect component or the Compton scatter component is split into at least two different frequency components.

5. The system of claim 1, wherein the different types of projection data include projection data and a noise estimate for the projection data.

6. The system of claim 1, wherein the scan parameters include one or more of: a z-axis position of a subject support, an angular position of a radiation source, a width of a radiation beam emitted by the source, an angular position of a detector of a detector array, and a z-axis position of the detector.

7. The system of claim 1, further comprising:
a projection data processor configured to generate the different types of projection data.

8. The system of claim 1, further comprising:
a radiation source configured to emit x-ray radiation; and
a detector configured to detect x-ray radiation emitted by the radiation source and generate the same projection data therefrom.

9. The system of claim 1, wherein the different types of projection data are received from a computed tomography imaging system.

10. The system of claim 1, wherein the weight values include a single set of weight values for all of the different types of projection data, and all of the plurality of data interpolators utilize the same single set of weight values to process projection data.

11. The system of claim 1, wherein the weight values include at least a first set of weight values and a second set of different weight values, at least two of the plurality of data interpolators utilize only one of the first or second set of weight values, and at least one different one of the plurality of data interpolators utilizes the other of the first or second set of weight values.

12. A non-transitory computer readable medium encoded with computer executable instructions which, when executed by a processor, cause the processor to:
compute, with only one backprojector:
geometry values only once for each voxel position in a volumetric image data matrix from scan parameters of a single computed tomography scan;
one or more sets of weight values for each voxel position in the volumetric image data matrix from scan parameters of the single computed tomography scan and the geometry values; and
interpolate and add, using the same geometry values and using the one or more sets of weight values, a respective different type of projection data produced from projection data from the same single computed tomography scan to generate volumetric image data based on the volumetric image data matrix and corresponding to the respective different type of projection data.

13. The non-transitory computer readable medium of claim 12, wherein the projection data is multi-energy projection data, and the different types of projection data includes spectral projection data for at least two different energy spectrums.

14. The non-transitory computer readable medium of claim 12, wherein the different types of projection data include projection data and a noise estimate of the projection data.

15. The non-transitory computer readable medium of claim 12, wherein the scan parameters include one or more of: a z-axis position of a subject support, an angular position of a radiation source, a width of a radiation beam emitted by the source, an angular position of a detector of a detector array, or a z-axis position of the detector.

16. The non-transitory computer readable medium of claim 13, wherein the computer executable instructions, when executed by the processor, further cause the processor to:
generate the different types of projection data.

17. The non-transitory computer readable medium of claim 13, wherein the computer executable instructions, when executed by the processor, further cause the processor to:
receive the different types of projection data from a computed tomography imaging system.

18. A method, comprising:
computing, with a single backprojector, geometry values only once for each voxel position in a volumetric image data matrix from scan parameters of a single computed tomography scan;
computing, with the single backprojector, weight values for each voxel position in the volumetric image data matrix from scan parameters of the single computed tomography scan and the geometry values; and
interpolating and adding, with the single backprojector, different types of projection data, which are produced from a same projection data from the same single computed tomography scan, using the same geometry values and using the weight values to generate volumetric image data based on the volumetric image data matrix and corresponding to the respective different type of projection data.

19. The method of claim 18, wherein the projection data is multi-energy projection data, and the different types of projection data includes spectral projection data for at least two different energy spectrums.

20. The method of claim 18, wherein the different types of projection data include projection data and noise variances of the projection data.
